(19) United States
(12) Patent Application Publication
(10) Pub. No.: US 2021/0390504 A1
(43) Pub. Date: Dec. 16, 2021

(54) DISTRIBUTED ARCHITECTURES FOR TRUST IN SHIPPING

(71) Applicant: Grant D Adkins, (US)

(72) Inventor: Grant D Adkins, Grand Forks, ND (US)

(21) Appl. No.: 17/304,060

(22) Filed: Jun. 14, 2021

Related U.S. Application Data
(60) Provisional application No. 62/705,202, filed on Jun. 16, 2020.

(51) Int. Cl. G06Q 10/08; H04L 9/08

(52) U.S. Cl. CPC G06Q 10/0833; H04L 9/0861

(57) ABSTRACT

A computer-implemented method of enabling a user to ship a parcel from an access point, according to various embodiments, comprises receiving, from a user device, a request to ship a parcel, the request including shipping information; at least partially in response to receiving the request, generating a digital key, and associating the digital key with the request; attaching the digital key to the parcel; receiving the parcel at a destination, and reading the digital key from the parcel at the destination; and confirming receipt of the parcel using the digital key.

### BACKGROUND

Trust issues are common in shipping. Consigners want evidence that the correct party received the package. Consignees do not want to pay until they have the shipment in their possession. Carriers want shipment records to prove they properly executed the shipment. Further, all parties want this information to be accurate and recorded on a platform that is free from tampering and manipulation. Accordingly, there is a need for improved shipping solutions to provide trust amongst shippers, receivers, and carriers.

### BRIEF SUMMARY

Embodiments of the present invention include computer-implemented methods, executable code, computer systems, and devices that support distributed architectures for providing trust in shipping.

A computer-implemented method of enabling a user to ship a parcel from an access point, according to various embodiments, comprises: (1) receiving, from a user device, a request to ship a parcel, the request including shipping information; (2) at least partially in response to receiving the request, generating a digital key, and associating the digital key with the request; (3) attaching the digital key to the parcel; (4) receiving the parcel at a destination, and reading the digital key from the parcel at the destination; and (5) confirming receipt of the parcel using the digital key.

### BRIEF DESCRIPTION OF DRAWINGS

FIG. 1 shows a distributed architecture computing system according to an embodiment of the present invention.

FIG. 2 shows a user device and parcel tag according to an embodiment of the present invention.

FIG. 3 shows a digital key method for ensuring trust using distributed architectures according to an embodiment of the present invention.

FIG. 4 shows a digital signature method for ensuring trust using distributed architectures according to an embodiment of the present invention.

FIG. 5 shows a communication key method for ensuring trust using distributed architectures according to an embodiment of the present invention.

FIG. 6 shows a method for ensuring trust for N nodes and X parties according to an embodiment of the present invention.

FIG. 7 shows a method of receiving a parcel tag according to an embodiment of the present invention.

FIG. 8 shows a method of attaching a parcel tag according to an embodiment of the present invention.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art.

Embodiments of the invention incorporate the use of computer security techniques within the shipping industry. The embodiments can utilize digital keys as a means to ensure trust between shipping parties. Advantages of the invention include increased computer security (e.g., prevention of man in the middle attacks, establishing identities of parties), maintaining liability with the proper party as a parcel is in transit, and providing a trustworthy source for parties that need shipping and shipping transit information.

Trust in computing is a broad term for solving computer security problems by customizing and modifying hardware and software. Distributed architectures are computer systems that share a network and coordinate their activities. Computer systems in distributed architectures coordinate their activities using messages to pursue common goals. In parallel computing, shared memory is used as a hub for processors to share information. Embodiments of the invention can utilize concepts from distributed architectures to improve trust in shipping.

Embodiments of the present invention can be applied to virtually any shipping scenario. Scenarios can include an online store and product purchaser, a store return, shipping containers, two private parties sending and receiving an item, medical shipments, prescription drug shipments and pickups, shipping with transitions between multiple carriers, shipments in which payment for the product is due on arrival, shipments with money held in escrow, shipments where financial liability transfers as the parcel transfers between parties, shipments where postage is due on arrival, anonymous shipping and receipt of goods, dynamic routing (changing an address mid-shipment, or establishing a new address after the item has been shipped) and the shipping of high-value items.

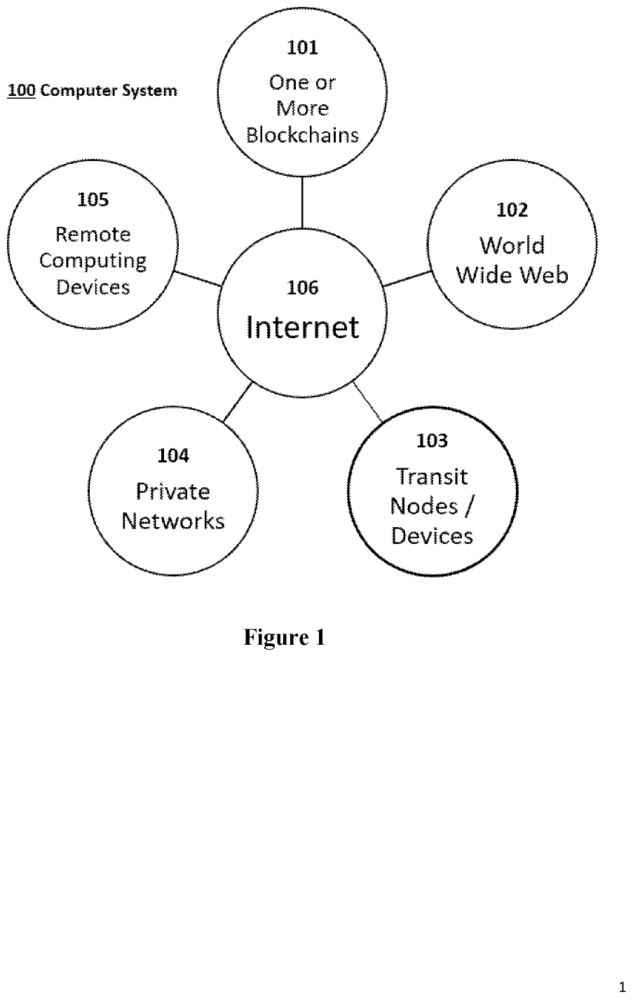

FIG. 1 shows a computer system according to an embodiment of the present invention. The system 100 can include the internet 106 as the network for communication amongst various devices, entities, and private networks. The internet 106 can support one or more blockchains 101 for recording shipping request information, shipping transit information, shipment confirmations, payment information, and smart contracts. A decentralized open-source blockchain featuring smart contract functionality, such as Ethereum, is an example of a platform suited to support the embodiments of the present invention.

The World Wide Web 102 can also be mined to obtain various information that impacts shipping, payment, money held in escrow, and other automated actions. This can take the form of entries in a blockchain. One or more transit nodes 103 can write-to and read information from parcel tags, weigh parcels, take parcel dimensions, and perform other functions. Information can be transmitted to and from parcel tags using wired or wireless electronic communication methods. Parcel tags can also be in non-electronic, such as a barcode or QR Code. Private networks 104 and remote computing devices 105 can be incorporated for supporting various functions, users, and entities.

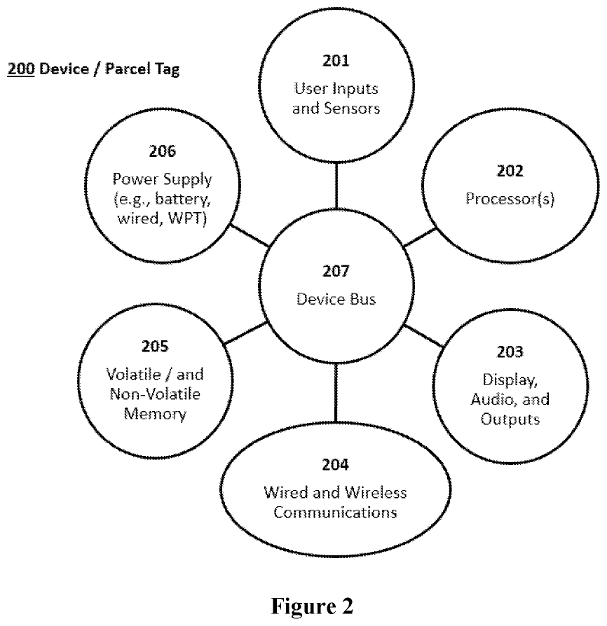

FIG. 2 demonstrates a user device and an electronic parcel tag 200 according to an embodiment of the present invention. Although one figure is used to demonstrate a user device and a parcel tag, the user device and parcel tag will generally take different forms and have different configurations. Specifically, the parcel tag is physically attached to a parcel, and the user devices communicates with the parcel tag and interfaces with users.

A user device or parcel tag 200 may have more or less elements than those shown in FIG. 2. The user devices can be in the form of a handheld electronic device (e.g., a cellular phone, carrier scanner), a laptop, as well as commercial automated scanners that would handle large volumes of parcels. User devices and automated scanners can be located at kiosks and carrier nodes (e.g., receiving, transfer, and delivery points), such as where packages are received, delivered, sorted, weighed, and measured. The parcel tag 200 shown in FIG. 2 is an electronic parcel tag, which is one form of parcel tag. The electronic parcel tag can receive, store, process, and send information though a wired or wireless connection. The parcel tag is configured to physically attach to a parcel or shipping container (inside or on the surface) while in transit. The parcel tag can also be physical in the form of a barcode or QR-Code label.

A user device 200 can include a device bus 207 that connects various modules. The hardware of the device can include non-volatile and volatile memory 205, one or more processors 202, and wired and wireless communications 204. A user device can include one or more user inputs and sensors 201. The inputs can include keyboards, touch screens, and microphones. The sensors can include scales, parcel measurement and dimensions sensors, barcode scanners, QR-Code scanners, as well as other types of sensors. The devices can wirelessly communicate with parcel tags via Bluetooth®, WIFI®, infrared, radio waves, and other means 204. The device can further include displays, audio, and outputs 203. The outputs can include electronic parcel tag attachment (and data transfer) to a parcel, as well as barcode or QR-Code labeling.

The parcel tags 200 can come in the form of a sticker having encapsulated electronic components. Sensors including accelerometers (e.g., for measuring shocks), magnetometers, light detectors, tamper detection, electromechanical locking mechanisms, GPS units (for tracking parcel location), temperature measurement devices (e.g., a thermometer or thermocouple), and antennas can be included within a parcel tag 200. These sensors are useful for all parties to know the shipping history of parcels, establish trust, and establish liability for damaged or lost parcels.

The devices 200 may use wired power or battery power as a power supply 206. In contrast, the parcel tags 200 will typically be have no internal power source, or will use a battery 206. Parcel tags 200 with no internal power source can be excited by a wireless power transmitter of a device 200, such as a passive RFID tag. The wireless power source can short-range or long-range. Short-range wireless power transfer mechanisms can include inductive coupling, resonant coupling, capacitive coupling, and magneto dynamic coupling. Long-range and directable wireless power transfer mechanisms can include electromagnetic waves.

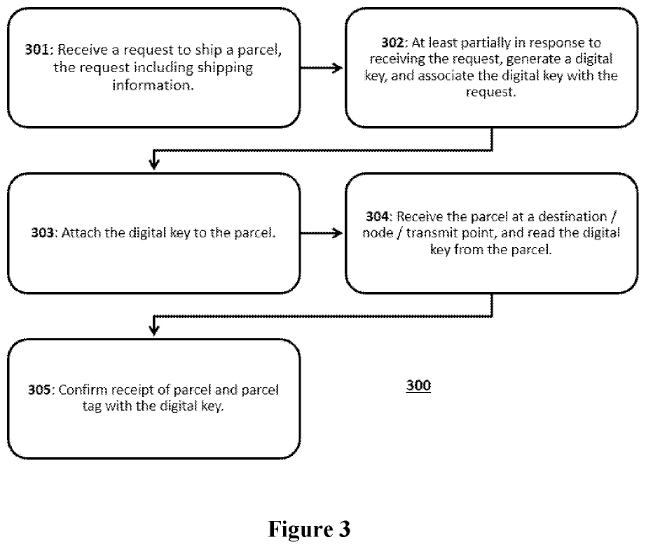

FIG. 3 shows a digital key method for ensuring trust using distributed architectures according to an embodiment of the present invention. In Step 301, a request is received to ship a parcel, with the request including shipping information. The shipping request can be acquired by a user device 200. A user device can be a mobile electronic device, a laptop or personal computer, a cellular phone, or a carrier reader or scanner. The shipping information can include sender and recipient names and addresses, postage, order numbers, order costs, shipping costs, shipping speed, serial numbers, product information, shipping dates, routing information, shipping plans, insurance information, one or more carrier codes, carrier names, and other data.

At least partially in response to receiving the request, the method includes generating a digital key (or set of digital keys) and associating the digital key with the request 302. The digital keys can be generated with a random alphanumeric key generator. The keys can be symmetric, asymmetric, or a combination of both. The keys can include pairs or sets of public and private keys. The digital keys are unique in that they are random, non-sequential, and act to secure trust. The digital keys can be applied inside private networks and recorded elsewhere, such as within a blockchain.

The digital key or the key set can then be attached to (i.e., recorded on) a parcel using a parcel tag 303, or multiple parcel tags. Shipping information can be attached to and stored in the parcel tag. The parcel tag can be an electronic device or physical labeling. The physical labeling can include one or more bar scanner codes, QR codes, and alpha-numerical identifiers (analog parcel tags with analog keys). Electronic parcel tags can include RFID tags and other electronic devices 200, both passive and active, which hold digital keys. A parcel tag can also include both physical labeling and an electronic parcel tag, and one or more keys can be stored in each parcel tag. The key from the physical labeling can be used to read the information from the electronic parcel tag, or vice versa.

In step 304, the parcel is received at a destination, or node (transit point where packages pass through on their way to the destination), and the digital key is read from the parcel. The digital key can be read wirelessly from an electronic parcel tag or a non-electronic parcel tag (e.g., a QR Code). In response, the entity in control of the destination device (e.g., a carrier at a transit point, or a final recipient) can then confirm receipt of the parcel using the digital key.

The confirmation 305 of receipt of the parcel can take various forms. The digital key can be used to communicate directly with the entity that created the digital keys, the sender, the recipient, a carrier, as well as other entities. For example, the destination device can confirm the receipt of the package by transmitting the key to private networks or servers (e.g. operated by a carrier, a sender, or receiver), a sender device, or one or more blockchains.

The digital keys can be used to transmit shipping transit information (i.e., information stored by a parcel tag during shipping) via an encrypted channel. In this way, the party confirming receipt of the package may not have access to or alter the shipping information on the tag (e.g. shipping transit information). Once the receiving device relays the information, the information may be published for all parties of concern to view. The digital keys can also be used to create digital signatures to sign shipping transit and receipt information.

Shipping transit information can be recorded (e.g., on a private server or blockchain) using the digital keys. Shipping transit information can include shipping logs with Time vs. GPS stamps, confirmations and timestamps of a parcel at various transit points (e.g., the times at which a parcel arrives at and leaves a carrier node), temperature measurements (e.g., tables and graphs over time, minimums, and maximums), number of transit shocks (e.g., >10 g, >50 g, >100 g), carrier transfer information, dimensions (e.g. at each node), weight (e.g., at each node), as well as other information that can be collected while a package is in transit.

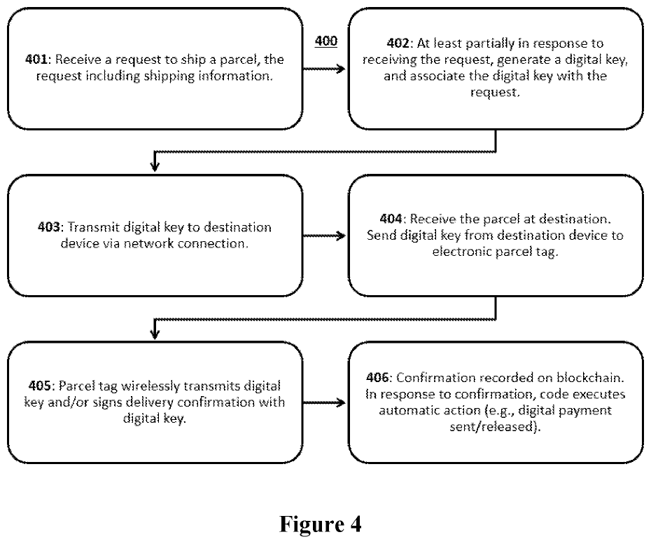

FIG. 4 shows a digital signature method for ensuring trust using a distributed architecture according to an embodiment of the present invention. The method can include receiving a request to ship a parcel 401 and, in response, generating a digital key (or key set), and associating the key with the request 402. The digital key can then be transferred to a destination device (a device controlled by the receiver or at a destination node) 403 via a network (e.g., the internet or a private network). When the parcel having a parcel tag is received at the destination, the destination device 200 transmits the digital key (or set of keys) to the parcel tag. The parcel tag can then confirm the parcel arrival with the digital keys received from the destination device. In another example, the parcel tag can confirm the receipt using the digital keys and transmit confirmation information (e.g., information stamped with a digital signature) back to the destination device. The destination device can then relay the information to a private network, blockchain, or other party (e.g., the sender). In one example, the parcel tag transmits information (to a sender, receiver, caner, private network, or blockchain) through a cellular network.

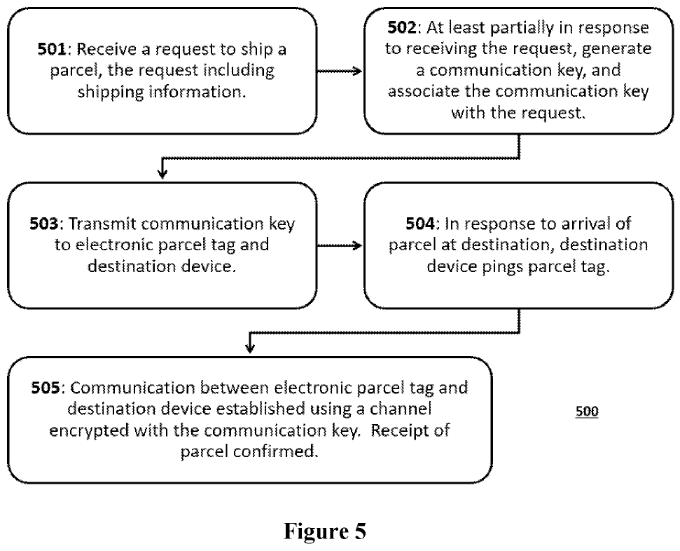

FIG. 5 shows a communication key method for ensuring trust using a distributed architecture according to an embodiment of the present invention. The method begins by receiving a request to ship a parcel, which includes shipping information 501. In response to the request, a communication key is generated, and the communication key is attached to the parcel 502. The communication key can be transmitted to an electronic parcel tag, which physically accompanies the parcel 503. The communication key can also take the form of a barcode or QR-Code on a parcel. Digital communication keys can be transmitted via a network to a destination device 503 (e.g, via the internet, private networks, cellular networks, or satellite networks). When the parcel and parcel tag arrive at a destination, the destination device can read the parcel tags 504. Encrypted and protected communications between the parcel tag and destination device can be established using the communication key. After establishing protected communications, the parcel delivery can be confirmed 505 via a blockchain, digital signature, or other means.

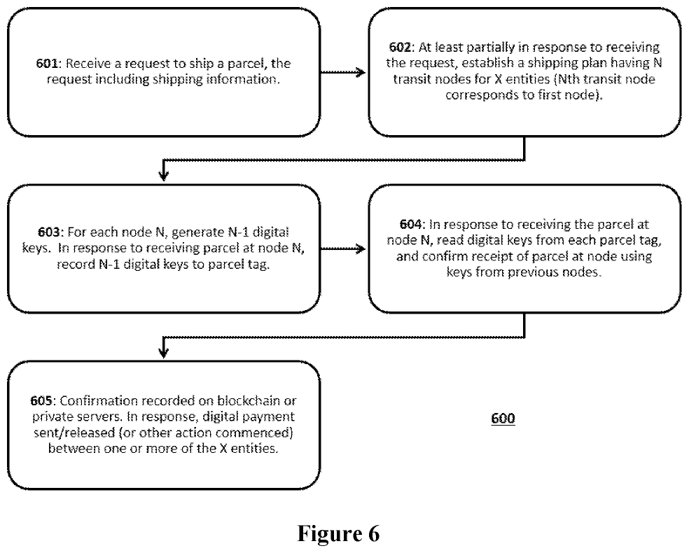

FIG. 6 shows a method for ensuring trust for N nodes and X parties according to an embodiment of the present invention. The method begins with a request to ship a parcel, the request including shipping information 601. At least partially in response to receiving the request, a shipping plan having N transit nodes for X entities is established (e.g., the Nth transit node corresponds to the first node) 602. Further, in response to receiving the request, N−1 digital keys can be generated for each node N. The N−1 digital keys can be attached to the parcel tag at node N 603, such that each node N can attach N−1 digital keys to the parcel. This would mean a digital key (or set of keys) for each future node (or transit point) in the shipping plan. In certain circumstances, it may be beneficial to implement the method with more or less than N−1 digital keys attached to the package. For example, one carrier may desire more or less transit point monitoring for various reasons.

The parcel is transported from node N to node N−1. In response to receiving the parcel at node N−1, the digital keys are read from each parcel tag 604. The digital keys from previous nodes can be used to sign the confirmation of receipt of the parcel at node N−1 604. In one example, node N corresponds to entity X (e.g., a carrier), and node N−1 corresponds to entity Y (e.g., another carrier).

At least partially in response to receiving the digital keys from the parcel, the delivery is confirmed 605. As with all delivery confirmations discussed herein, the confirmation (and transit information) can be recorded on public or private blockchains 605. Digital payments from entity X to X−1 can be automatically executed when entity X−1 takes control of the parcel from entity X. Each package can thus be tracked in a secure manner such that the entity in control of the parcel automatically assumes liability for the parcel. In one example, entity X−1 confirms receipt of the package using a digital key, and automatic payment is sent from entity X to entity X−1. The parcel can then ship to a next transit point (e.g., node N−2) of entity X−2, where the receipt of the package is confirmed using digital keys, and payment is sent from entity X−1 to entity X−2, and so on for each entity in the shipping plan.

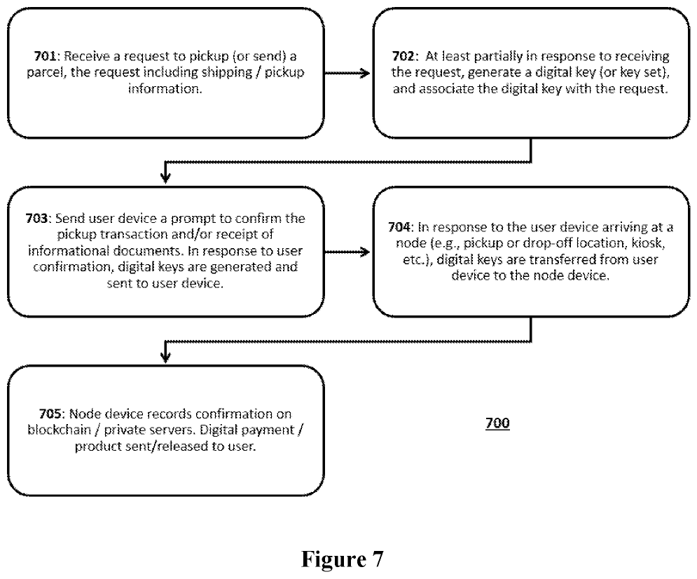

FIG. 7 shows a method of secure parcel pickup and dropoff according to an embodiment of the present invention. The method begins with receiving a request to pick up or ship a parcel, the request including pickup information 701. At least partially in response to receiving the request, a digital key (or key set) is generated and associated with the request 702. A prompt can then be sent to a user device to confirm the pickup transaction 703. The prompt can include various informational documents (e.g., such as legal documents, pharmacy/drug paperwork, dosing, and therapeutic information). This information can be stored in the user device such that the user can review the documents at a later time. The generation of digital keys may be at least partially in response to the confirmation of receipt of the informational materials, the generation of a pickup or dropoff request, or both.

In response to the user device arriving at a node (e.g., pickup or dropoff location, pharmacy, kiosk, a pickup vehicle, etc.), digital keys are transferred from the user device to the node device, from the node device to the user device, or both. As with other transmissions of information and digital keys, the data transfer can take the form of wireless communication or scanning of a barcode or QR code (e.g., a barcode generated on a user mobile device). The node device can then record confirmation and transit information on blockchains and private servers. In response, various actions can automatically execute such as the transfer of physical control of the parcel (e.g., medication or a product), monitoring, or automatic payment. Monitoring can include retaining information regarding distribution of controlled substances, hazardous material logs, as well as other functions.

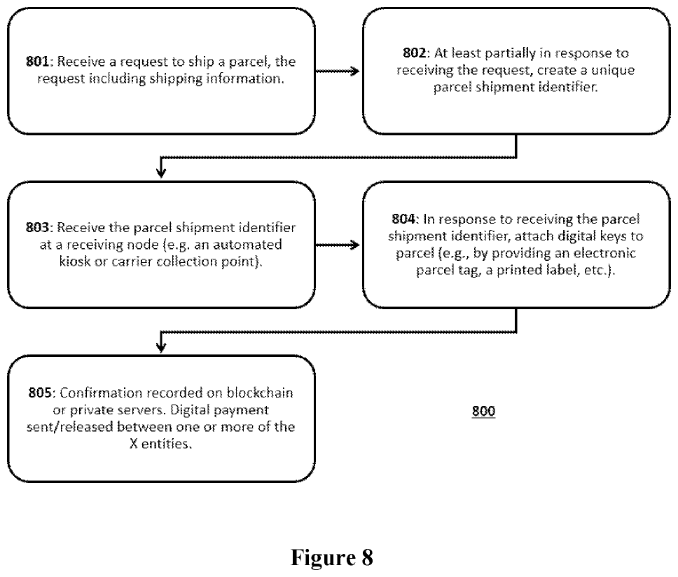

FIG. 8 shows a method of attaching a parcel tag according to an embodiment of the present invention. The method starts with a request to ship a parcel, the request including shipping information 801. At least partially in response to receiving the request, a unique parcel shipment identifier is created 802. The parcel shipment identifier can be a digital key, in one embodiment. The parcel shipment identifier is received at the receiving node (e.g. an automated kiosk or carrier collection point) 803, and the parcel is physically handed off from a user to an entity that controls the receiving node. In response to receiving the parcel shipment identifier, digital keys are physically attached to the parcel (e.g., by providing an electronic parcel tag or a printed label) 804. Confirmation of receipt of the parcel can then be recorded on a blockchain, private servers, or both 805.

The digital keys discussed can come in various forms and have various functions. Embodiments of the invention can include generating key pairs (e.g., public and private key pairs). Private keys can be used to sign information, and the public keys can be used to verify the signature. Therefore, the private keys must be transferred through a secure channel (e.g., physically via a parcel tag, or through a network connection). Encryption in the embodiments can be accomplished using a public key, while only the party with the private key can decrypt the information. Digital signatures can be applied in the embodiments to provide the advantage of securing the message, as a digital signature is dependent on the message. Therefore, no other party can modify a message once it is signed, and trust in reported shipping information is assured.

Applications of the present invention should take into account that asymmetric keys are generally big and slow, while symmetric keys are usually small and fast. A private key can be used to encrypt, and the public key can be used to decrypt and verify the sender. A public and private key pair can be used to establish communications and a symmetric key to encrypt transit and other information.

Confirmations in the invention can include the use of smart contracts. The smart contracts can include code that automatically executes when a parcel transfer or arrival is confirmed via a parcel tag. The automatic actions can include automatic payment transfers (using cryptocurrencies and digital currencies) as well as physical responses such as opening a lock and allowing access to a parcel or location. The methods of the present invention can include smart contracts that have redundant trust features. For example, release of funds or other automated action can execute in response to parcel tag confirmation at two or more nodes within a specified period of time, or other requirements. Requiring confirmation at two or more nodes can ensure the shipping plan was executed correctly and the receipt is genuine.

Embodiments of the invention can utilize various types of blockchains. This includes public, private, and hybrid blockchains. Blockchains can represent digital assets. Public blockchains have no access restrictions, and all that is needed is an internet connection to validate and confirm a shipping transaction at a node. Economic incentives can be offered for parties that secure the blockchain. Although not necessary, Proof of Work and Proof of Stake principals can be applied. Public blockchains that can be applied to the embodiments include Bitcoin, Ethereum, Tether, Ripple, Bitcoin Cash, Bitcoin SV, Litecoin, EOS, Monero, Dash, and Stellar.

In contrast to public blockchains, private blockchains require permission, and therefore a party cannot partake unless invited by network administrators. The digital keys discussed herein can be used to control what parties can participate and validate in private blockchains. The parties that maintain the blockchain can include one or more carriers, one or more insurance companies, a private entity, or a consortium of entites.

Hybrid blockchains can be utilized in the embodiments of the invention. Hybrid blockchains include a combination of centralized, decentralized, public, and private features. Hybrid blockchains can be highly customizable, and their function can vary based on which aspects should be centralized and decentralized. For example, one or more private parties (e.g., a carrier or insurance company) may support a private blockchain that interfaces with a public blockchain.

Sidechains can also be utilized in the embodiments of the present invention. Sidechains are blockchain ledgers that execute in parallel to a primary blockchain. Sidechains can link back and forth with one or more primary blockchains. Sidechains can use an alternative form of storing data and keeping records and therefore implement unique solutions. For example, a private blockchain can confirm shipping transactions and automatically make payment via cryptocurrency.

Digital certificates can be applied to any of the presented methods. Digital certificates are electronic credentials that allow people, computers, and entities to establish their identity online. Similar to an identification card, digital certificates are issued by a Certificate Authority and contain the identity of the owner along with a public key. Cryptographic hash functions can also be applied. A hash function turns a message into a fixed-length Digest. The hash functions should be well distributed (look random), collision-resistant, and computationally efficient.

Geofences can be implemented in the embodiments as a triggering event for establishing communications and confirming deliveries. For example, a communication from the parcel tag to the destination device can be in response to a parcel tag crossing a geofence. The geofence can be a perimeter around a carrier route, or a radius around a delivery point (e.g., within 100 m of a delivery point).

Embodiments of the invention can be particularly advantageous in anonymous shipping and dynamic routing. For example, a user may make a shipping request and receive one or more digital keys. Shipping information that is input by the user is associated with the digital keys and stored remotely. As the digital keys are scanned at transit points, the final address can be retrieved using the digital keys. In response, the address is retrieved and attached to the parcel. The address can be attached electronically using an electronic parcel tag, or the address can be attached via physical labeling. Embodiments can be used for dynamic routing in much the same fashion. That is, the destination address can be changed while transportation of the parcel is in progress by using the digital keys to access information that is protected through encryption.

Embodiments of the present invention may also be applied to peer-to-peer ridesharing and autonomous vehicle transport. Much the same as with shipping a package, digital keys can be created in response to a ride or courier request. The digital keys can be transferred to a user device, a vehicle device, or both. The digital keys can then be passed from the user device to the vehicle device, as well as from the vehicle device to the user device. In some embodiments, communications between the vehicle device and user device can be established using a digital key. The user device can then communicate with the vehicle device, and both the vehicle device and user device can confirm transit information relating to the ride or delivery.

Embodiments of the invention can be implemented on various apps such as those for handheld mobile devices. User accounts can be implemented and maintained by a distributed network, a private network, or a hybrid of two or more networks. Embodiments can incorporate package storage lockers, kiosks, designated consumer package shipment devices, and carrier pickup and dropoff locations. Embodiments of the invention can operate with large volume carrier processing facilities, shipping pods, and shipping containers.

One skilled in the art will understand that the various methods discussed herein can be used in combination or layered on top of one another (e.g., any two, three, four, or all of methods 300, 400, 500, 600, 700, and 800 can be used simultaneously). In fact, each of the methods can serve to complement the others in unique and interesting ways to provide comprehensive distributed architecture systems and methods for ensuring trust in shipping.

Many modifications and other embodiments of the invention will be apparent to one skilled in the art to which this invention pertains, after having the benefit of the teachings presented in the foregoing descriptions and the associated drawings. Specific examples have been given, but the invention may be readily used in other contexts. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

1. A distributed architecture method of enabling a user to ship a parcel with trust, the method comprising:
receiving, from a user device, a request to ship a parcel, the request including shipping information;
at least partially in response to receiving the request, generating a digital key, and associating the digital key with the request;
attaching the digital key to the parcel;
receiving the parcel at a destination, and reading the digital key from the parcel at the destination; and
confirming receipt of the parcel using the digital key.

2. The distributed architecture method of claim 1, wherein confirming receipt of the parcel using the digital key further comprises:
generating a confirmation message, and signing the message using the digital key.

3. The distributed architecture method of claim 2, wherein confirming receipt of the parcel using the digital key further comprises recording the signed message on a block chain.

4. The distributed architecture method of claim 3, further comprising: at least partially in response to recording the signed message on the block chain, executing an electronic payment.

5. The distributed architecture method of claim 3, further comprising: receiving confirmation of receipt of the parcel at an access point by at least reading the digital key from the parcel.

6. The distributed architecture method of claim 5, wherein the digital key is a set of keys, and different keys are utilized at the access point and the destination.

7. The distributed architecture method of claim 1, wherein attaching the digital key to the parcel comprises physically labeling the parcel with a printed label.

8. The distributed architecture method of claim 1, wherein attaching the digital key to the parcel comprises sending the digital key to a passive electronic parcel tag.

9. The distributed architecture method of claim 1, wherein attaching the digital key to the parcel comprises sending the digital key to an active electronic parcel tag.

10. The distributed architecture method of claim 1, further comprising:
generating a communication key and attaching the communication key to the parcel;
transmitting the communication key to the destination using a network; and
reading the digital key from the parcel at the destination using a channel encrypted by the communication key.

11. The distributed architecture method of claim 5, further comprising: generating an access point key, attaching the access point key to the parcel at the access point, and reading the access point key at the destination.

12. The distributed architecture method of claim 9, further comprising reading transit information at the destination, and wherein the active tag is a device that senses and records the transit information.

13. The distributed architecture method of claim 10, wherein generating the communication key includes generating a public key and a private key, transmitting the private key to the destination using a network, and attaching the public key to the parcel.

14. The distributed architecture method of claim 10, wherein generating the communication key includes generating a public key and a private key, transmitting the public key to the destination using a network, and attaching the private key to the parcel.

15. The distributed architecture method of claim 12, wherein the method further includes: generating a transit information key, encrypting the transit information with the transit information key, generating encrypted transit information, and sending the encrypted transfer information.

16. The distributed architecture method of claim 15, wherein the transit information key is stored the user device.

17. The distributed architecture method of claim 4, wherein the electronic payment is executed via a smart contract on a blockchain.

18. The distributed architecture method of claim 1, wherein the digital key is included with other digital keys in a key set, and each of the other digital keys correspond to a different node.

19. A distributed architecture method of enabling a user to ship a parcel with trust, the method comprising:
receiving, from a user device, a request to ship a parcel, the request including shipping information;
at least partially in response to receiving the request, generating a digital key and a transit information key, and associating the digital key and the transit information key with the request;
attaching the digital key to the parcel, and recording the transit information key on a blockchain;
sensing and recording transit information and storing the transit information with an active electronic parcel tag;
receiving the parcel at a destination, and reading the digital key from the parcel at the destination;
reading the encrypted transit information from the active delivery tag;
decrypting the encrypted transit information using the transit information key to produce the transit information;
storing the transit information or the encrypted transit information on the blockchain; and
confirming receipt of the parcel using the digital key.

20. A distributed architecture method of enabling a user to ship a parcel with trust, the method comprising:
receiving, from a user device, a request to ship a parcel, the request including shipping information;
at least partially in response to receiving the request, generating a digital key and a parcel identifier, and associating the digital key and the parcel identifier with the request;
attaching the digital key to the parcel;
attaching the parcel identifier to the parcel;
in response to reading the parcel identifier at an access point, confirming receipt of the parcel and the access point;
transporting the parcel from the access point to a destination;
receiving the parcel at the destination, reading the digital key from the parcel at the destination; and
confirming receipt of the parcel using the digital key.
